(19) United States
(12) Patent Application Publication
(10) Pub. No.: US 2026/0201137 A1
(43) Pub. Date: Jul. 16, 2026

(54) FOAMED GLASS FIBER-REINFORCED THERMOPLASTIC COMPOSITION

(71) Applicant: SABIC GLOBAL TECHNOLOGIES B.V., Bergen op Zoom (NL)

(72) Inventors: Johannes Peter Antonius MARTENS, Geleen (NL); Maria SOLIMAN, Selfkant (DE); Kar-Man Raymond CHU, Maastricht (NL); Ting HUANG, Shanghai (CN)

(21) Appl. No.: 19/136,461

(22) PCT Filed: Dec. 11, 2023
(86) PCT No.: PCT/EP2023/085101

§ 371 Date: Jun. 6, 2025

(30) Foreign Application Priority Data
Dec. 12, 2022 (WO) PCT/CN2022/138354
Feb. 7, 2023 (EP) 23155433.8

(51) Int. Cl. C08J 9/34; C08J 9/00; C08K 7/14; C08L 23/0807; C08L 23/12

(52) U.S. Cl. CPC C08J 9/34; C08J 9/0061; C08J 9/0085; C08K 7/14; C08L 23/0815; C08L 23/12; C08J 2323/08; C08J 2323/12; C08J 2423/06; C08L 2203/14; C08L 2203/30; C08L 2205/025

(57) ABSTRACT

The present invention relates to a foamed glass fiber-reinforced thermoplastic composition comprising, based on a total weight thereof, (a) 30-90 wt % of a thermoplastic polymer matrix, (b) 10-70 wt % of glass fibers and (c) 0.5-20 wt % of an impregnating agent, wherein the density reduction rate of the foamed glass fiber-reinforced thermoplastic composition is at least 30%, wherein the density reduction rate is calculated as (d_{unfoamed}−d_{foamed})/d_{unfoamed}, in which d_{foamed} is the density of the foamed glass fiber-reinforced thermoplastic composition, and d_{unfoamed} is the density of the same glass fiber-reinforced thermoplastic composition which is un-foamed. The present invention also relates to a method to produce the foamed glass fiber-reinforced thermoplastic composition, as well as to an article produced from the foamed glass fiber-reinforced thermoplastic composition. Because of the low dielectric constant of the foamed glass fiber-reinforced thermoplastic composition, the produced article can be used in various fields and applications, such as in antenna housing or cover.

### CROSS REFERENCE TO RELATED APPLICATIONS

This application is a National Stage Application of PCT/EP2023/085101, filed Dec. 11, 2023, which claims the benefit of Application No. PCT/CN2022/138354, filed Dec. 12, 2022, and European Application No. 23155433.8, filed Feb. 7, 2023, both of which are incorporated by reference in their entirety herein.

### BACKGROUND

The present invention relates to a foamed glass fiber-reinforced thermoplastic composition, further to a method to produce the foamed glass fiber-reinforced thermoplastic composition, as well as to an article produced from the foamed glass fiber-reinforced thermoplastic composition. Because of the low dielectric constant of the foamed glass fiber-reinforced thermoplastic composition of the invention, the produced article can be used in various fields and applications, such as in antenna housing or cover.

In traditional telecommunication (3G, and 4G) applications, the antenna and their enclosures made mainly out of plastic materials, such as engineering thermoplastics (ETP), fulfill market needs regarding allowance of electromagnetic waves to pass the materials with lower losses in order for high speed signal connection in every house and public room.

The frequency range of the electromagnetic waves of 4G is 3 GHz and the peak data rate is 1 Gb/s. The di-electrical constant Dk of these ETP materials are typically larger than 2.6 and the loss factor Df is larger than 0.005.

The frequency range that is envisioned for the new generation 5G telecommunication networks globally lies above 20 GHz and the peak data rate above 20 Gb/s. It means that the di-electrical properties like the di-electrical constant (Dk) and di-electrical loss (Df) of the plastic materials needs to be lowered in order to avoid any signal losses in the high speed connection.

The Dk and Df values of currently used plastic materials (PC, PC blends) at high frequencies are not suitable to fulfill the di-electrical property needs for 5G. Information of the E&E market proves that the Dk and Df requirements of these materials for the 5G applications are sharpened in comparison with those in 4G environments, in a typical 5G environment, Dk should be less than 3 and Df should be less than 0.005, at nominal frequencies of for example 1.0 GHz.

The regularly used plastic parts mostly based on ETP do have significantly higher di-electrical (Dk, Df) values than required and therefore are not suitable for fulfilling the 5G di-electrical requirements.

It appears that increasing the thickness means heavier weight of the plastic part, which in most cases of the applications is not preferred, resulting in for example unsafe or unhealthy ergonomic situation for persons in terms of physical heavy labor work.

It is already known in the art that materials with intrinsic lower Dk/Df values, like polypropylene (PP) and polyethylene (PE), help to lower down the Dk and Df values of the parts made from them.

### SUMMARY

The present invention has found that foamed glass fiber-reinforced thermoplastic compositions possess lower dielectric constants than the same glass fiber-reinforced thermoplastic compositions un-foamed. Plastic parts made from such foamed thermoplastic compositions include (air) voids inside, which help in lowering down the Dk/Df values but also in significant reduction in weight. A lower weight, because of a lower density, means that the antenna cover or housings parts are less heavy in weight and more ergonomic for construction people in handling these parts.

In the context of the present invention, the term “mass” and “weight” are used interchangeably. The term “mass %” has the same meaning as the term “weight %” or simply “wt %”.

In the context of the present invention, an amount/content of a specific component in a percentage (“%”) is on weight basis, unless clearly specified otherwise.

In the context of the present invention, the term “degree Celsius” or “° C.” is sometimes simplified as “C”. For example, “190 C” means “190° C.”, as is known to a skilled person in the field.

In the context of the present invention, the singular forms “a”, “an” and “the” are intended to include the plural forms as well, unless the context clearly indicates otherwise.

In the context of the present invention, the term “comprise” or “include” also includes the meanings of “comprised of”, “essentially comprised of”, “consist of” or “essentially consist of”.

In the context of the present invention, any numerical values describing a same aspect/feature of the present invention throughout the disclosure can be combined together to form a new range. For example, when it is described in the context that an amount of a certain component is at least 1 wt %, preferably at least 2 wt %, and at most 5%, preferably at most 4 wt %, being in one example specifically 3 wt %, then the amount ranges of 1-2 wt %, 2-3 wt %, 3-4 wt %, 4-5 wt %, 1-5 wt %, 2-4 wt % etc, are all inherently disclosed, as if they were explicitly described in the present invention. For example, when it is described in the context that an amount of a certain component is in the range of 1-5 wt %, preferably 2-4 wt %, being in one example specifically 3 wt %, then the amount ranges of 1-2 wt %, 2-3 wt %, 3-4 wt %, 4-5 wt %, etc, are all inherently disclosed, as if they were explicitly described in the present invention.

In the present invention, a glass fiber-reinforced thermoplastic composition is a thermoplastic composition reinforced with glass fibers.

In the present invention, a thermoplastic composition comprises, based on a total weight thereof:
(a) 30-90 wt % of a thermoplastic polymer matrix, and
(b) 10-70 wt % of glass fibers.

In some instances, the thermoplastic composition further comprises:
(c) 0.5-20 wt % of an impregnating agent which is non-volatile, has a melting point of at least 20° C. below the melting point of the thermoplastic polymer matrix, has a viscosity, measured in accordance with ASTM D 3236-15, of from 2.5 to 100 cS at application temperature, and is compatible with the thermoplastic polymer matrix.

In some instances, the thermoplastic composition further comprises:
(d) 5-20 wt % of at least one polyolefin based elastomer.

In one aspect of the present invention, there is provided a foamed glass fiber-reinforced thermoplastic composition, which comprises, based on a total weight thereof:
(a) 30-90 wt % of a thermoplastic polymer matrix, and
(b) 10-70 wt % of glass fibers,
wherein the density of the foamed glass fiber-reinforced thermoplastic composition is reduced by at least 30% based on the density of the same glass fiber-reinforced thermoplastic composition which is un-foamed, in other words, the density reduction rate of the foamed glass fiber-reinforced thermoplastic composition is at least 30%, wherein the density reduction rate is calculated as (d_{unfoamed}−d_{foamed})/d_{unfoamed}, in which d_{foamed} is the density of the foamed glass fiber-reinforced thermoplastic composition, and d_{unfoamed} is the density of the same glass fiber-reinforced thermoplastic composition which is un-foamed.

### DETAILED DESCRIPTION

According to the present invention, by foaming an unfoamed glass fiber-reinforced thermoplastic composition, the density of the glass fiber-reinforced thermoplastic composition is reduced by a percentage of at least 30%. In some instances, the density of the foamed glass fiber-reinforced thermoplastic composition is reduced by at least 35%, preferably at least 40%, more preferably at least 45%, based on the density of the same glass fiber-reinforced thermoplastic composition, which is un-foamed.

In some instances, the density of the foamed glass fiber-reinforced thermoplastic composition is reduced by at most 70%, preferably at most 65%, more preferably at most 60%, based on the density of the same glass fiber-reinforced thermoplastic composition, which is un-foamed.

In some instances, the density of the foamed glass fiber-reinforced thermoplastic composition is at most 800 kg/m³, preferably at most 700 kg/m³, more preferably at most 600 kg/m³, and even more preferably at most 500 kg/m³.

In some instances, the Dk value of the foamed glass fiber-reinforced thermoplastic composition tested at a frequency of 1.0 GHz, in accordance with GB 12636, is at most 2.50, preferably at most 1.90, more preferably at most 1.80, even more preferably at most 1.70, and still more preferably at most 1.60.

In some instances, the Dk value of the foamed glass fiber-reinforced thermoplastic composition tested at a frequency of 1.9 GHz, in accordance with GB 12636, is at most 2.50, preferably at most 2.10, more preferably at most 2.00, even more preferably at most 1.80, and still more preferably at most 1.70.

In some instances, the Df value of the foamed glass fiber-reinforced thermoplastic composition tested at a frequency of 1.0 GHz, in accordance with GB 12636, is at most 0.0015, preferably at most 0.0014, more preferably at most 0.0013, even more preferably at most 0.0012, and still more preferably at most 0.0011.

In some instances, the Df value of the foamed glass fiber-reinforced thermoplastic composition tested at a frequency of 1.9 GHz, in accordance with GB 12636, is at most 0.0030, preferably at most 0.0028, more preferably at most 0.0026, even more preferably at most 0.0024, and still more preferably at most 0.0023.

In some instances, the foamed glass fiber-reinforced thermoplastic composition is produce by foaming an un-foamed glass fiber-reinforced thermoplastic composition.

In some instances, the foamed glass fiber-reinforced thermoplastic composition is produce by foaming an un-foamed glass fiber-reinforced thermoplastic composition through an injection molding foaming (FIM) process or an extrusion foaming process.

In another aspect of the present invention, there is provided a foamable composition comprising the thermoplastic composition of the present invention and a foaming agent.

In another aspect of the present invention, there is provided a method to produce a foamed glass fiber reinforced thermoplastic composition, which comprises the sequential steps of:
i. providing a thermoplastic composition and a foaming agent, wherein the thermoplastic composition comprises, based on a total weight thereof:
(a) 30-90 wt % of a thermoplastic polymer matrix, and
(b) 10-70 wt % of glass fibers; and
ii. foaming the thermoplastic composition so that the density of the foamed glass fiber-reinforced thermoplastic composition is reduced by at least 30% based on the density of the same glass fiber-reinforced thermoplastic composition which is un-foamed, in other words, the density reduction rate of the foamed glass fiber-reinforced thermoplastic composition is at least 30%, wherein the density reduction rate is calculated as (d_{unfoamed}−d_{foamed})/d_{unfoamed}, in which d_{foamed} is the density of the foamed glass fiber-reinforced thermoplastic composition, and d_{unfoamed} is the density of the same glass fiber-reinforced thermoplastic composition which is un-foamed.

In another aspect of the present invention, there is provided an article produced from the foamed glass fiber-reinforced thermoplastic composition of the present invention.

In another aspect of the present invention, there is provided an article comprising a core layer and two adjacent surface layers, wherein the core layer is produced from the foamed glass fiber-reinforced thermoplastic composition of the present invention, and at least one of the surface layers is produced from an un-foamed thermoplastic composition.

In some instances, the article of the present invention is an antenna housing or an antenna cover.

### Thermoplastic Polymer

The glass fiber-reinforced thermoplastic composition of the present invention comprises a thermoplastic polymer matrix.

The thermoplastic polymer matrix comprises at least one thermoplastic polymer.

Suitable examples of the thermoplastic polymer include polyamides, such as polyamide 6, polyamide 66, or polyamide 46; polyolefins like polypropylenes and polyethylenes, including polyolefin homopolymer, copolymer or any blend thereof; polyesters, such as polyethylene terephthalate, polybutylene terephthalate; polycarbonates; polyphenylene ethers (PPE); polyphenylene sulphide (PPS); polyurethanes; also any type of polymer blends and compounds and any combinations thereon.

More particularly, polypropylene, polybutylene terephthalate and polyamide 6 may be used.

In some instances, the thermoplastic polymer is free of phthalates.

### Polypropylene

In some instances, the thermoplastic polymer matrix of the present invention comprises at least one polypropylene polymer, which can be (a1) a propylene homopolymer, (a2) a random copolymer of propylene and at least one other olefin, (a3) a propylene impact copolymer, (a4) a modified- or functionalized-propylene homopolymer or copolymer, or mixtures thereof.

The polypropylene is preferably crystallizable. The term “crystallizable” generally means that the polymer has an isotactic structure, i.e. its isotacticity is high, for instance higher than 95% and preferably higher than 98%.

A random copolymer generally contains at most about 20 mol % of other olefins as comonomer, preferably at most 10 mol %, to retain crystalline character. The at least one other olefin may be for instance an alpha-olefin, in particular a 1-alkene having for instance 2 or 4-20, preferably 4-12, carbon atoms or cyclic olefins, optionally containing more than one ring, having a double bond in the ring structure. Examples of suitable olefins include ethylene, butene, hexene, styrene, cyclopentene and norbornadiene. Preferably, the alpha-olefin is a 1-alkene having 2, 4, 6 or 8 carbon atoms, more preferably, the alpha-olefin is ethylene.

Preferably, the polypropylene polymer is a propylene impact copolymer, because this results in a favorable combination of stiffness and toughness. Propylene impact copolymers are also referred to as propylene block-copolymers or as heterophasic polypropylene copolymers. Such material basically has at least a two-phase structure, consisting of a crystalline propylene-based matrix and a dispersed elastomeric phase, typically an ethylene-olefin copolymer like an ethylene-propylene rubber (EPR). These polypropylenes are generally prepared in one or more reactors, by polymerization of propylene in the presence of a catalyst, and subsequent polymerization of an ethylene-olefin copolymer like an ethylene-propylene rubber (EPR), but may also be prepared by blending individual components, as is well known to a skilled person. The resulting polymeric materials are heterophasic, but their specific morphology usually depends on the preparation method and monomer types and ratios. In some instances, the polyolefin should have least one crystalline melting point (Tm) between 120 and 170 C wherein the Tm has a heat capacity (dHm) of at least 10 J/g. Tm and dHm are determined by DSC as per ASTM D3418 with a heating rate of 20 C/min.

Generally, the impact copolymer contains about 50-95 mass % of a crystalline propylene homo- or random-copolymer matrix, and about 50-5 mass % of dispersed copolymer of ethylene and at least one other olefin.

The amount of dispersed phase is preferably 10-35 mass %, more preferably 15-30 or 17-25 mass % of the total amount of heterophasic polymer, to arrive at a desired stiffness-impact balance in the composition according to the invention.

The dispersed phase comprises a copolymer of ethylene and at least one other olefin, preferably a C3 to C10 alpha-olefin. Examples of suitable C3 to C10 alpha-olefins include 1-butene, 1-pentene, 4-methyl-1-pentene, 1-hexene, 1-heptene and 1-octene. Preferably, an ethylene-propylene copolymer, known also as ethylene-propylene rubber (EPR) is used as the dispersed phase.

The amounts of the propylene-based matrix and the dispersed ethylene-olefin copolymer may be determined by NMR, as well known in the art.

Preferably, the propylene-based matrix is a propylene homopolymer.

Preferably, the melt flow index (MFI) of the propylene-based matrix (MFIPP) is at least 30 dg/min and at most 120 dg/min, measured according to ISO1133 (2.16 kg/230° C.). MFIPP may be for example at least 40 dg/min, at least 45 dg/min, at least 50 dg/min, at least 55 dg/min or at least 60 dg/min, and/or for example at most 110 dg/min, at most 100 dg/min, at most 90 dg/min or at most 80 dg/min, measured according to ISO1133 (2.16 kg/230° C.).

The propylene-based matrix is preferably semi-crystalline, that is, it is not 100% amorphous, nor is it 100% crystalline. For example, the propylene-based matrix is at least 40% crystalline, for example at least 50%, for example at least 60% crystalline and/or for example at most 80% crystalline, for example at most 70% crystalline. For example, the propylene-based matrix has a crystallinity of 60 to 70%. For purpose of the present invention, the degree of crystallinity of the propylene-based matrix is measured using differential scanning calorimetry (DSC) according to ISO11357-1 and ISO11357-3 of 1997, using a scan rate of 10° C./min, a sample of 5 mg and the second heating curve using as a theoretical standard for a 100% crystalline material 207.1 J/g.

The MFI of the dispersed ethylene-olefin copolymer (MFIEPR) may be for example at least 0.001 dg/min, at least 0.01 dg/min, at least 0.1 dg/min, at least 0.3 dg/min, at least 0.7 dg/min, at least 1 dg/min, and/or for example at most 30 dg/min, at most 20 dg/min, at most 15 dg/min, at most 10 dg/min, at most 5 dg/min, at most 3 dg/min, as measured according to ISO1133 (2.16 kg/230° C.).

The amount of ethylene in the ethylene-olefin copolymer is preferably in the range from 20 to 80 wt % based on the ethylene-olefin copolymer, more preferably, the amount of ethylene in the ethylene-olefin copolymer is from 30 to 70 wt %, more preferably from 40 to 65 wt %, more preferably from 50 to 65 wt %, even more preferably from 55 to 65 wt %.

Preferably, the α-olefin in the ethylene-α-olefin copolymer is propylene.

The MFI of the polypropylene polymer is in the range from 17 to 75 dg/min, preferably in the range from 20 to 60 dg/min, more preferably in the range from 25 to 55 dg/min, even more preferably in the range from 28 to 40 dg/min as measured according to ISO1133 (2.16 kg/230° C.).

The xylene soluble part of the polypropylene polymer according to the invention is in the range from 9.3 to 19.6 wt %, preferably in the range from 11.2 to 18.4 wt %, more preferably in the range from 12.4 to 17.4 wt % as measured according to by ISO16152:2005.

The intrinsic viscosity of the xylene soluble part of the polypropylene is preferably in the range from 1.2 to 4.6 dl/g, preferably in the range from 1.8 to 4.0 dl/g, even more preferably in the range from 2.3 to 3.5 dl/g as measured according to ISO1628-1:2009 in decalin at 135° C.

Preferably, the polypropylene has a crystalline melting point (Tm) of between 120 and 170 C, wherein the Tm has a heat capacity (dHm) of at least 10 J/g. Tm and dHm are determined by DSC as per ASTM D3418 with a heating rate of 20 C/min. In some instances, the polyolefin will be free of phthalates.

The thermoplastic polymer matrix may also contain a modified polypropylene; this generally improves properties by affecting glass fibers—polypropylene interactions. Examples of suitable modified polypropylenes are polypropylenes grafted with for instance an unsaturated organic compound, like a carboxylic acid, an anhydride, an ester, glycidyl esters or salts thereof. Suitable examples include maleic, fumaric, (meth)acrylic, itaconic or cinnamic acid or anhydride, ester or carboxylic acid salt thereof. Preferably, maleic anhydride is used. The amount of modified polypropylene may vary widely, but for economic reasons the amount normally will be rather low, for instance less than 5 mass %, preferably less than 4, 3, 2 or even 1 mass % (based on total composition).

The polypropylene polymer according to present invention can be produced using any conventional technique known to the skilled person, for example multistage process polymerization, such as bulk polymerization, gas phase polymerization, slurry polymerization, solution polymerization or any combinations thereof. Any conventional catalyst systems, for example, Ziegler-Natta or metallocene may be used. Such techniques and catalysts are described, for example, in WO06/010414; Polypropylene and other Polyolefins, by Ser van der Ven, Studies in Polymer Science 7, Elsevier 1990; WO06/010414; U.S. Pat. Nos. 4,399,054 and 4,472,524. Preferably, the polypropylene is made using Ziegler-Natta catalyst.

### Glass Fibers

In general, glass fiber is a glassy cylindrical substance where its length is significantly longer than the diameter of its cross section. It is known that adding glass fibers is able to improve the mechanical performance (e.g. strength and stiffness) of polymeric matrix. The level of performance improvement depends heavily on the properties of the glass fibers, e.g. diameter, length and surface property of the glass fiber.

The thermoplastic composition comprises 10-70 mass % of glass fibers, preferably 5-25 mass %, and more preferably 5-20 mass %.

In some instances, the glass fibers of the present invention have a length of 1-50 mm. A composition containing glass fibers of length greater than 1 mm is generally referred to as a long glass fiber (LGF) reinforced composition, for example a LGF PP composition.

In contrast, short glass fiber compositions or compounds typically contain fibers of length below 1 mm. Such compounds are typically made by mixing chopped strands of pre-determined length with a thermoplastic polymer in an extruder, during which the glass fibers are dispersed in the molten thermoplastic. Because of fiber breakage occurring during this process the fiber length is decreased. Upon molding the composition into an article, the fibers are further reduced in size.

Long glass fiber-reinforced polymer compositions in the form of, for example, pellets or granules can be prepared from continuous lengths of fibers by a sheathing or wire-coating process, by crosshead extrusion or several pultrusion techniques. Using these technologies, fiber strands impregnated or coated with a polymer are formed; these may then be cut into lengths, and the pellets or granules thus obtained can be further processed, e.g. by injection molding or extrusion processes, into (semi)-finished articles.

In a pultrusion process, a bundle of continuous glass filaments is spread out into individual filaments and drawn through an impregnation die, into which molten thermoplastic is injected, aiming at entirely wetting and impregnating each filament with the molten thermoplastic. A strand of diameter of about 3 mm is drawn from the die and then cooled. Finally, the strand is chopped into segments of the desired length. The glass fibers are generally parallel to one another in the segment, with each fiber being individually surrounded by the thermoplastic.

The process of sheathing or wire-coating is done without wetting fibers individually with thermoplastic, but by forming a continuous outer sheath, also called coating or skin, of a thermoplastic material around the continuous multifilament strand surface. The sheathed continuous strand is chopped into pellets or granules of desired length, e.g. for about 10 mm length, in which the fibers are generally parallel to one another and have the same length as the pellets or granules. Such pellets or granules comprise a core that extends in the axial direction and a thermoplastic polymer sheath intimately surrounding said core, wherein said core comprises a plurality of long glass fiber filaments and an impregnating agent, and the sheath is substantially free of said filaments. The LGF pellets are further supplied to an injection molding or compression molding machine, and during this molding step the glass fibers are dispersed within the thermoplastic polymer and formed into molded (semi)-finished articles. Documents EP 0921919 B1 and EP 0994978 B1 describe a typical sheathing or wire-coating method. WO2018109118A1 discloses wire-coated LGF pellets.

The average length of the glass fibers in the composition of the invention is preferably at least 2 mm, to result in higher strength and stiffness, more preferably at least 3, 4, 5 or even 6 mm. Too high a length may cause some problems, for example in processing or in surface appearance of the molded article, therefore the length of the glass fibers is preferably at most 40 mm, more preferably at most 30, 20 or 15 mm. A composition containing fibers of average length 0.1-10 mm is found to present an optimum in mechanical properties, shrinkage and scratch-resistance of the molded article obtained thereof.

The diameter of the glass fibers in the composition according to the invention is not very critical, but very thick fibers may result in a decrease of mechanical properties and/or lower surface quality. Generally, the diameter ranges from 5 to 50 microns, preferably from 5 to 30 microns, more preferably from 8 to 25 microns.

The amount of glass fibers affects mechanical properties, as well as processing and mold shrinkage behavior, and aesthetic aspects of the molded article obtained thereof and, depending on the desired properties profile, the amount can be optimized.

The filament density of the continuous glass multifilament strand may vary within wide limits. Preferably, the continuous multifilament strand may have of from 500 to 10000 glass filaments/strand and more preferably from 2000 to 5000 glass filaments/strand, because of high throughput. The diameter of the glass filaments in the continuous multifilament strand may widely vary. Preferably, the diameter of the glass filaments ranges from 5 to 50 microns, more preferably from 10 to 30 microns and most preferably from 15 to 25 microns. Glass filaments diameters outside these ranges tend to result in a decrease of mechanical properties and/or enhanced abrasion of the equipment used.

### Impregnating Agent

In one aspect of the present invention, the glass fiber-reinforced thermoplastic composition in the present invention preferably further comprises an impregnating agent.

The amount of the impregnating agent applied to the thermoplastic composition depends on the thermoplastic matrix, on the size (diameter) of the filaments forming the continuous strand, and on type of sizing that is on the surface of the fibers.

According to the present invention, the amount of impregnating agent applied to the thermoplastic composition should be at least 0.5% by mass, preferably it is at least 2% by mass, more preferably at least 4% by mass and most preferably at least 6% by mass; but should be at most 20% by mass, preferably it is at most 18% by mass, more preferably at most 15% by mass and most preferably at most 12% by mass. A certain minimum amount of impregnating agent is needed to assist homogeneous dispersion of glass fibers in the thermoplastic polymer matrix during moulding, but the amount should not be too high, because an excess of the agent may result in decrease of mechanical properties of the moulded articles.

It is found that the lower the viscosity, the less impregnating agent can be applied. For instance, in case the thermoplastic polymer matrix is polypropylene homopolymer with a melt index MFI of 25 to 65 g/10 min (230° C./2.16 kg) and the reinforcing long glass filaments have a diameter of 19 micron, the impregnating agent is preferably applied to the multifilament strand in an amount of from 2 to 10% by mass.

The impregnating agent used in the present invention is at least one compound that is compatible with the thermoplastic polymer matrix to be reinforced, enabling it to enhance dispersion of the glass fibers in the thermoplastic polymer matrix during the moulding process.

The viscosity of the impregnating agent should be at most 100 cS, preferably at most 75 cS and more preferably at most 25 cS at application temperature. The viscosity of the impregnating agent should be at least 2.5 cS, preferably at least 5 cS, and more preferably at least 7 cS at the application temperature. An impregnating agent having a viscosity higher than 100 cS is difficult to apply to the continuous glass multifilament strand. Low viscosity is needed to facilitate good wetting performance of the fibers, but an impregnating agent having a viscosity lower than 2.5 cS is difficult to handle, e.g., the amount to be applied is difficult to control; and the impregnating agent could become volatile. Without wishing to be bound to any theory, the inventors believe that the impregnation of the continuous glass multifilament strands, without separating or spreading of individual filaments, by the impregnating agent is driven mainly by capillary forces.

For purpose of the invention, unless otherwise stated, the viscosity of the impregnating agent is measured in accordance with ASTM D 3236-15 (standard test method for apparent viscosity of hot melt adhesives and coating materials, Brookfield viscometer Model RVDV 2, #27 spindle, 5 r/min) at 160° C.

The melting point of the impregnating agent is at least about 20° C. below the melting point of the thermoplastic matrix. Without being wished to be bound to any theory, the inventors think this difference in melting points, and thus in solidification or crystallisation points, promotes fiber impregnation also after applying the thermoplastic sheath and cooling the sheathed strand, and fiber dispersion during subsequent moulding. Preferably, the impregnating agent has a melting point at least 25 or 30° C. below the melting point of the thermoplastic matrix. For instance, when the thermoplastic polymer matrix is polypropylene having a melting point of about 160° C., the melting point of the impregnating agent may be at most about 140° C.

The application temperature is chosen such that the desired viscosity range is obtained, and is preferably below the self-ignition temperature of the impregnating agent. For example, when the matrix is polypropylene, the application temperature of the impregnating agent can be from 15 to 200° C.

According to the present invention, the impregnating agent should be compatible with the thermoplastic polymer to be reinforced, and may even be soluble in said polymer. The skilled man can select suitable combinations based on general knowledge, and may also find such combinations in the art. Suitable examples of impregnating agents include low molar mass compounds, for example low molar mass or oligomeric polyurethanes, polyesters such as unsaturated polyesters, polycaprolactones, polyethyleneterephthalate, poly(alpha-olefins), such as highly branched polyethylenes and polypropylenes, polyamides, such as nylons, and other hydrocarbon resins. As a general rule, a polar thermoplastic polymer matrix requires the use of an impregnating agent containing polar functional groups; a non-polar polymer matrix involves using an impregnating agent having non-polar character, respectively. For example, for reinforcing a polyamide or polyester, the impregnating agent may comprise low molecular weight polyurethanes or polyesters, like a polycaprolactone. For reinforcing polypropylenes, the impregnating agent may comprise highly branched poly(alpha-olefins), such as polyethylene waxes, modified low molecular weight polypropylenes, mineral oils, such as, paraffin or silicon and any mixtures of these compounds. Preferably, the impregnating agent comprises a highly branched poly(alpha-olefin) and, more preferably, the impregnating agent is a highly branched polyethylene wax, in case the thermoplastic polymer to be reinforced is polypropylene; the wax optionally being mixed with for example from 10 to 80, preferably 20-70, mass % of a hydrocarbon oil or wax like a paraffin oil to reach the desired viscosity level.

According to the present invention, the impregnating agent is non-volatile, and substantially solvent-free. Being non-volatile means that the impregnating agent does not evaporate under the application and processing conditions applied; that is it has a boiling point or range higher than said processing temperatures. In the context of present application, “substantially solvent-free” means that impregnating agent contains less than 10% by mass of solvent, preferably less than 5% by mass solvent. Most preferably, the impregnating agent does not contain any organic solvent.

### Polyolefin-Based Elastomer

In one aspect of the present invention, the glass fiber-reinforced thermoplastic composition in the present invention preferably further comprises a polyolefin-based elastomer.

The polyolefin-based elastomer is preferably selected from a group consisting of ethylene-1-butene copolymer, ethylene-1-hexene copolymer, ethylene-1-octene copolymer and mixtures thereof, more preferably, the elastomer is selected from ethylene-1-octene copolymer. Most preferably, the elastomer is an ethylene-1-octene copolymer.

Preferably the density of the polyolefin based elastomer is in the range from 0.845 to 0.883 g/cm3, preferably in the range from 0.848 to 0.865 g/cm3, more preferably in the range from 0.853 to 0.860 g/cm3 as measured according to ASTM D792-13.

Preferably the MFI of the polyolefin based elastomer is in the range from 0.5 to 18.0, preferably in the range from 0.8 to 14.2 dg/min as measured according to ASTM D1238-13, 190° C., 2.16 kg.

The shore A hardness of the polyolefin based elastomer is preferably in the range from 35 to 90, preferably in the range from 42 to 69, more preferably in the range from 47 to 60 as measured according to ASTM D2240-15, 1s.

It was surprisingly found that the thermoplastic composition according to the present invention comprising a polyolefin based elastomer having an MFI in the range from 0.8 to 14.2 dg/min as measured according to ASTM D1238-13,190° C., 2.16 kg and a density in the range from 0.853 to 0.860 g/cm3 as measured according to ASTM D792-13 has an excellent falling weight impact resistance at −40° C.

The polyolefin-based elastomers which are suitable for use in the current invention are commercially available for example under the trademark EXACT™ available from Exxon Chemical Company of Houston, Texas, or under the trademark ENGAGE™ polymers, a line of metallocene catalyzed elastomers available from Dow Chemical Company of Midland, Michigan, or under the trademark TAFMER™ available from MITSUI Chemicals Group of Minato Tokyo, or under the trademark Fortify™ and Cohere™ available from SABIC.

The polyolefin-based elastomers may be prepared using methods known in the art, for example by using a single site catalyst, i.e., a catalyst the transition metal components of which is an organometallic compound and at least one ligand of which has a cyclopentadienyl anion structure through which such ligand bondingly coordinates to the transition metal cation. This type of catalyst is also known as “metallocene” catalyst. Metallocene catalysts are for example described in U.S. Pat. Nos. 5,017,714 and 5,324,820. The elastomer s may also be prepared using traditional types of heterogeneous multi-sited Ziegler-Natta catalysts.

Preferably, the amount of ethylene incorporated into the polyolefin-based elastomer is at least 45 wt %. More preferably, the amount of ethylene incorporated into the polyolefin based elastomer is at least 48 wt %, for example at least 50 wt %. The amount of ethylene incorporated into the polyolefin based elastomer may typically be at most 95 wt %, for example at most 85 wt %, for example at most 75 wt %, for example at most 65 wt %, for example at most 60 wt %, for example at most 58 wt %.

The amount of the polyolefin-based elastomer is preferably in the range from 5 to 20 wt %, more preferably in the range from 7 to 15 wt % based on the total amount of the thermoplastic composition.

### Other Additives

The thermoplastic composition of the present invention may further optionally comprise 0-20 mass % of other additives. This includes customary additives like nucleating agents, clarifiers, stabilizers, release agents, plasticizers, anti-oxidants, UV stabilizers like HALS compounds, colorants, flame-retardant additives, minerals, lubricants like calcium stearate, mold release agents, flow enhancers and/or anti-static agents. The skilled person will know how to select the type and amount of additives when needed, and to apply them in such amount that they do not detrimentally influence the aimed properties of the composition.

In order to further enhance especially scratch resistance, also anti-scratch additives like silicones may be added, as is know from other publications.

In an example of the present composition, it comprises one of more of the following additives:
0.05 to 5.0% of a nucleant such as talc, metal stearate or the like,
0.10 to 0.8% of a mold release such as fatty acid esters e.g. PETS (pentaerythritol tetra stearate) or GMS (glycerol mono stearate), fatty acid amides e.g. EBS wax, polyolefins and the like,
0.1 to 1.0% of antioxidants such as hindered phenols, phosphorus containing stabilizers, thioesters, lactones or combinations thereof,
0.1 to 5% of colorants such as carbon black and zinc sulfide, and in some instances less than 100 ppm titanium dioxide that may break glass fiber reducing fiber length and impair mechanical property performance.

In some instances, the composition may further comprise glass-resin coupling agents such as alkoxy silanes, amino silanes, zirconates, titanates, and maleic anhydride (MA) or glycidyl methacrylate (GMA) modified polyolefins such as PEgGMA, PPgMA, to improve GF resin adhesion.

### Production of Thermoplastic Composition

The composition according to the invention can be made with known processes, for example by mixing all components, except for the glass fiber, on an extruder, to obtain the composition of pellet or granule form. The composition can also be made by blending different pellets of different compositions.

Preferably, the composition is a mixture of pellets of different compositions, and contains a masterbatch (or concentrate) of glass fibers; that is a composition based on the polymer matrix and 30-75 mass % of long glass fibers. The polymer matrix, such as polypropylene, in this masterbatch is as above described for polypropylene according to the invention, and may be the same as or different from the polypropylene in other pellets. The advantage hereof is that the LGF PP compound can be made in an efficient way, and the total amount of glass fibers in the final composition, and in the further molded article, can be easily adjusted to optimize performance. Preferably, the masterbatch contains 35-70, 40-65, or 45-60 mass % of glass fibers.

The molded article according to the invention can be a semi-finished or finished article made from the polypropylene composition by a molding process. Examples of suitable molding processes include injection molding, compression molding, extrusion and extrusion compression molding. Injection molding is most widely used to produce articles such as automotive parts. A semi-finished article may subsequently undergo further known processing steps. The article according to the invention preferably has a so-called textured surface, which further reduces sensitivity to and/or visibility of surface damage like scratches.

Generally, the length of glass fibers in a polymer composition decreases during a melt processing step like injection molding. The average length of the glass fibers in the molded article made from the composition according to the invention may vary widely, depending on both starting length and processing conditions. Preferably, the average fiber length in the molded article is at least 0.5, 0.6, 0.7, 0.8 or 0.9 mm, and most preferably between about 1 and 5 mm.

### Foamed Thermoplastic Composition

In one aspect of the present invention, the foamed glass fiber-reinforced thermoplastic composition is produced by foaming an un-foamed glass fiber-reinforced thermoplastic composition through an injection molding foaming process (FIM) or an extrusion foaming process.

Among the various injection molding foaming processes known in the art, it is preferred that the foamed glass fiber-reinforced thermoplastic composition is prepared in a core-back injection molding process.

The reason that a core-back injection molding process is preferred is that such a process leads to a foamed product with a higher level of density reduction. The core-back injection molding process can also be referred to as mold opening process.

A typical core-back injection molding process comprises the following sequential steps:
Providing a thermoplastic composition and a foaming agent to the injection molding machine;
Injecting the molten mixture of the thermoplastic composition and the foaming agent into a mould;
Opening the mold, at least partially, to allow the mixture to form a soft foamed thermoplastic composition and;
Allowing the soft foamed thermoplastic composition to solidify to form a foamed thermoplastic composition and eject the foamed thermoplastic composition from the mould.

The foaming agent according to the invention can either be a physical foaming agent or a chemical foaming agent. The chemical foaming agent is a chemical that decomposes at a specific temperature to liberate gas(es), while the physical foaming agent is either a volatile liquid(s) or gas(es).

A typical chemical foaming agent includes but is not limited to azodicarbonamide, sodium bicarbonate and citrate derivatives.

A typical physical foaming agent includes but is not limited to fluids such as nitrogen, carbon dioxide, hydrocarbons (e.g. butane, pentane), in gaseous or supercritical state, and their mixtures.

The amount of the foaming agent used in the present invention can be varied depending on its nature and the foaming performance of the foaming agent. In some instances, the amount of the foaming agent varies in the range of 1-5 wt % based on the total weight of the thermoplastic composition and the foaming agent, preferably in the range of 2-3 wt %.

In some instances, an article is directly produced from a thermoplastic composition by the FIM process, in particular the core-back injection molding process.

In some instances, a monolithic article is produced from the foamed thermoplastic composition, which is produced by the FIM process.

In some instances, a layered article is produced from the foamed thermoplastic composition. The layered article may comprise two, three, four, or five etc. layers, in which at least one of them is produced from the foamed thermoplastic composition. In the case of a three layered article which comprises a core layer and two adjacent surface layers, the core layer is produced from the foamed thermoplastic composition, and at least one of the surface layers is produced from an un-foamed thermoplastic composition, which can be the same with or different from the thermoplastic composition before foaming.

### Experimental Examples

Foamed and unfoamed specimens were prepared via injection moulding using an Arburg Allrounder 520H 1500-800 unit, and measured for dielectric properties, as reported in table 1 below.

A composition of 98 wt % of STAMAX 30YM240 (commercially available from SABIC, which is a 30% long glass fiber reinforced grade thermoplastic composition according to the invention) and 2 wt % of Hydrocerol ITP818 chemical foaming agent masterbatch (commercially available from Avient) was prepared by dry blending, in the form of a mixture of pellets.

The mixture of the pellets was then added to the hopper of the injection-moulding machine, which was set at a barrel temperature of 250° C., and a mould temperature of 40° C.

The mixture of pellets were hot melted before the molten mixture was injected into a mould cavity of 1.5 mm (nominal) thickness; afterwards, the mould was opened partially to an additional distance of 0.75 mm and 1.5 mm, resulting foamed specimens with a density of 679 kg/m³ (Example 1) and 518 kg/m³ (Example 2), respectively.

A second set of samples were made with a mould cavity of 2.0 mm (nominal) thickness; afterwards, the mould was opened partially to a distance of 1.0 mm, resulting foamed specimens with a thickness of 3.0 mm and a density of 661 kg/m³ (Example 3).

In addition, unfoamed STAMAX 30YM240 specimens with a thickness of 1.5 mm (comparative example 1) and 2.0 mm (comparative example 2) were prepared using the same conditions, except that no chemical foaming agent was mixed with the STAMAX pellets and no partial opening of the mould cavity was used during the moulding process.

All example specimens were measured on di-electrical properties of Dk and Df values at frequencies of 1.0 GHz and 1.9 GHz. For purpose of the invention, unless otherwise stated, the Dk and Df values at the frequency of 1.0 GHz was measured by the Parallel Plate Capacitor Method (Impedance Analyzer), and the Dk and Df values at the frequency of 1.9 GHz was measured using the Split Post Dielectric Resonator (SPDR) method, both measured in accordance with GB 12636 method “Stripline test method for complex permittivity of microwave dielectric substrates”. Before testing, the specimens were prepared and pre-dried at a temperature of 120° C. for 90 minutes and then cooled down to room temperature inside the drying vessel.

Moreover, density was measured according to ISO 1183-1:2004.

TABLE 1

| Example No. | Comp. Ex. 1 | Example 1 | Example 2 | Comp. Ex. 2 | Example 3 |
|---|---|---|---|---|---|
| Form | Unfoamed | Foamed | Foamed | Unfoamed | Foamed |
| Nominal thickness (mm) | 1.5 | 2.25 | 3 | 2 | 3 |
| Estimated foaming ratio* | n.a. | 33% | 50% | n.a. | 33% |
| Density (kg/m³) | 1145 | 679 | 518 | 1130 | 661 |
| Weight reduction** | n.a. | 41% | 55% | n.a. | 42% |
| Dk (1.0 GHz) (STC-K) | 2.67 | 1.84 | 1.67 | 2.52 | 1.83 |
| Df (1.0 GHz) (STC-K) | / | 0.0012 | 0.0013 | / | 0.0014 |
| Dk (1.9 GHz) (STC-S) | 2.67 | 2.00 | 1.76 | 2.71 | 1.98 |
| Df (1.9 GHz) (STC-S) | 0.0027 | 0.0027 | 0.0024 | 0.0026 | 0.0028 |

*Estimated foaming ratio = [1 − (thickness of foamed specimen)/(thickness of unfoamed specimen)]*100%
**Weight reduction = [1 − (density of foamed specimen)/(density of unfoamed specimen)]*100%

It appears that the di-electrical properties of the foamed LGF PP improves significantly, with lower Dk values and comparable Df values, so is the significant increase in weight reduction. The foamed LGF PP is therefore applicable for new application areas like 5G antenna cover or housing parts, being more ergonomic for construction people as well.

1. A foamed glass fiber-reinforced thermoplastic composition comprising, based on a total weight thereof:
(a) 30-90 wt % of a thermoplastic polymer matrix,
(b) 10-70 wt % of glass fibers, and
(c) 0.5-20 wt % of an impregnating agent,
wherein the density reduction rate of the foamed glass fiber-reinforced thermoplastic composition is at least 30%, wherein the density reduction rate is calculated as (d_{unfoamed}−d_{foamed})/d_{unfoamed}, in which d_{foamed} is the density of the foamed glass fiber-reinforced thermoplastic composition, and d_{unfoamed} is the density of the same glass fiber-reinforced thermoplastic composition which is un-foamed.

2. The foamed glass fiber-reinforced thermoplastic composition of claim 1, wherein the density reduction rate is at least 35%.

3. The foamed glass fiber-reinforced thermoplastic composition of claim 1, wherein the density reduction rate is at most 70%.

4. The foamed glass fiber-reinforced thermoplastic composition of claim 1, wherein,
the Dk value of the foamed glass fiber-reinforced thermoplastic composition tested at a frequency of 1.0 GHz, in accordance with GB 12636, is at most 1.90, and/or
the Df value of the foamed glass fiber-reinforced thermoplastic composition tested at a frequency of 1.0 GHz, in accordance with GB 12636, is at most 0.0015.

5. The foamed glass fiber-reinforced thermoplastic composition of claim 1, wherein,
the Dk value of the foamed glass fiber-reinforced thermoplastic composition tested at a frequency of 1.9 GHz, in accordance with GB 12636, is at most 2.10, and/or
the Df value of the foamed glass fiber-reinforced thermoplastic composition tested at a frequency of 1.9 GHz, in accordance with GB 12636, is at most 0.0030.

6. The foamed glass fiber-reinforced thermoplastic composition of claim 1, wherein the foamed glass fiber-reinforced thermoplastic composition is produced by foaming an un-foamed glass fiber-reinforced thermoplastic composition through an injection molding foaming process or an extrusion foaming process.

7. The foamed glass fiber-reinforced thermoplastic composition of claim 1, wherein the glass fiber-reinforced thermoplastic composition is in pellet form comprising a core that extends in the axial direction and a thermoplastic polymer sheath intimately surrounding said core, wherein said core comprises a plurality of long glass fiber filaments and the impregnating agent, and the sheath is substantially free of said filaments.

8. The foamed glass fiber-reinforced thermoplastic composition of claim 1, further comprising
(d) 5-20 wt % of at least one polyolefin based elastomer.

9. The foamed glass fiber-reinforced thermoplastic composition of claim 1, wherein the thermoplastic polymer matrix comprises at least one polypropylene polymer.

10. The foamed glass fiber-reinforced thermoplastic composition of claim 7, wherein the impregnating agent is a polyethylene wax.

11. The foamed glass fiber-reinforced thermoplastic composition of claim 8, wherein the polyolefin based elastomer is an ethylene-1-octene copolymer.

12. A process for producing a foamed glass fiber reinforced thermoplastic composition, which comprises the sequential steps of:
i. providing a thermoplastic composition and a foaming agent, wherein the thermoplastic composition comprises, based on a total weight thereof:
(a) 30-90 wt % of a thermoplastic polymer matrix,
(b) 10-70 wt % of glass fibers, and
(c) 0.5-20 wt % of an impregnating agent; and
ii. foaming the thermoplastic composition so that the density reduction rate of the foamed glass fiber-reinforced thermoplastic composition is at least 30%, wherein the density reduction rate is calculated as (d_{unfoamed}−d_{foamed})/d_{unfoamed}, in which d_{foamed} is the density of the foamed glass fiber-reinforced thermoplastic composition, and d_{unfoamed} is the density of the same glass fiber-reinforced thermoplastic composition which is un-foamed.

13. An article produced from the foamed glass fiber-reinforced thermoplastic composition of claim 1.

14. An article comprising a core layer and two adjacent surface layers, wherein the core layer is produced from the foamed glass fiber-reinforced thermoplastic composition of claim 1, and at least one of the surface layers is produced from an un-foamed thermoplastic composition.

15. The article of claim 13, wherein the article is an antenna housing or an antenna cover.
